(19) United States
(12) Patent Application Publication
(10) Pub. No.: US 2025/0131786 A1
(43) Pub. Date: Apr. 24, 2025

(54) ELECTRONIC MONEY BOX

(71) Applicant: Maayan ZAHAV, Shaarey Tikva (IL)

(72) Inventor: Maayan ZAHAV, Shaarey Tikva (IL)

(21) Appl. No.: 18/830,637

(22) Filed: Sep. 11, 2024

Related U.S. Application Data
(63) Continuation-in-part of application No. 17/993,890, filed on Nov. 24, 2022, now abandoned.
(60) Provisional application No. 63/286,137, filed on Dec. 6, 2021.

(51) Int. Cl. G07D 11/00; G06Q 30/0279; G07D 11/23; G07D 11/60

(52) U.S. Cl. CPC G07D 11/0093; G06Q 30/0279; G07D 11/0096; G07D 11/23; G07D 11/60

(57) ABSTRACT

A device and system for an electronic money box for receiving money in cash and/or as an electronic contribution, and/or reporting the amount of money contained therein for the purpose of donating charity and/or saving money and/or investing and/or transferring funds.

### RELATED APPLICATION/S

This application claims the benefit of priority under 35 USC § 119 (e) of U.S. Provisional Patent Application No. 63/286,137 filed 6 Dec. 2021, the contents of which are incorporated herein by reference in their entirety.

### TECHNICAL FIELD

The present invention, according to some embodiments thereof, relates to an electronic money box and, more particularly, but not exclusively which may be designed for the purpose of donating charity and/or saving money and/or investing and/or transferring funds.

### BACKGROUND OF THE INVENTION

Savings boxes, such as piggy banks, charity boxes, etc., have been around for centuries. Generally, a savings box is sealed and the amount of money in the savings box is not known until after the money box is opened. Often, unsealing a savings box damages the money box beyond repair for further use. Electronic savings boxes which
count the money inserted require bill/coin recognizing hardware and/or software, which may be expensive. Therefore, such systems are not in wide distribution in homes and/or shops.

US Patent Publication no. 2008/0006649 appears to disclose, “An apparatus and method for promoting voluntary contributions, such as to charitable causes, in association with an automated merchandising machine. The apparatus comprises a collection container with a lockable access door, the container adapted for mounting to an automated merchandising machine.”

US Patent Publication no. 2008/0033855 appears to disclose, “The invention can also serve to promote or distribute goodwill (e.g., the promotion of a sponsor's goodwill 3 and/or the distribution to those in need). An electronic apparatus, hereinafter a donation station (also referred to as “The Charity Box”) facilitates a user in making a charitable donation.”

U.S. Pat. No. 10,080,410 appears to disclose, “A charity box device, wherein the display shows: a. the daily total of charitable acts for the charity box device; b. the lifetime total of charitable acts for the charity box device; c. the daily total of charitable acts for all the charity box devices connected to the database.”

US Patent Publication no. 2016/0247131 appears to disclose, “a charity box or digital donation box is based on a donation or charity box or kiosk. And when a customer or user finds a charity box to give left over change the user has few available options.”

Additional art includes U.S. Pat. Nos. 8,672,134, 10,842,195, 8,863,256, US Patent Publication no. 2020/039766, US Patent Publication no. 2015/0351456, U.S. Pat. No. 10,887,125, US Patent Publication no. 2019/0163876.

Therefore, there is a need for an electronic savings box for receiving money (e.g., donations, savings, etc.) and/or reporting the amount of money contained therein for the purpose of donating charity and/or saving money and/or investing and/or transferring funds.

### SUMMARY OF THE INVENTION

According to an aspect of some embodiments of the invention, there is provided an electronic money box including: a cash reservoir a cash insertion slot leading from outside reservoir into the cash reservoir; at least one means of receiving an electronic contribution from a user; a display, wherein the display is configured for electronic advertising of a plurality of charity campaigns; a processor configured to configured to control the display; and a network connection, wherein the electronic money box is connected through the network connection to at least one of: a financial institution, a monetary account of a charity, a monetary account of an individual, additional electric money boxes, and an internet site of the charity campaign.

According to some embodiments of the invention, the display is configured to display donor dedication specified by a donor to the money box.

According to some embodiments of the invention, the display is configured to display donor dedication specified by a donor to at least one of the plurality of campaigns made without use of the money box.

According to some embodiments of the invention, the electronic money box further includes a user interface connected to the display, wherein the user interface is configured for selection of at least one of the plurality of charity campaigns.

According to some embodiments of the invention, the cash insertion slot and cash reservoir are configured to accept coins, bills, or both.

According to some embodiments of the invention, the electronic money box further includes a sensor to detect entry of a cash donation.

According to some embodiments of the invention, the sensor is configured to identify an inserted coins or bills.

According to some embodiments of the invention, the sensor includes a proximity sensor, an optical sensor, or both.

According to some embodiments of the invention, the electronic money box is configured to accept a contribution from a debit card, credit card, or financial mobile application.

According to some embodiments of the invention, the user interface is via the display.

According to some embodiments of the invention, the user interface includes a mobile application running on an external device owned by the user.

According to some embodiments of the invention, the network connection includes a wireless connection selected from a cellular network, satellite network, Wi-Fi, Bluetooth, near field communication system, or any combination thereof.

According to some embodiments of the invention, the electric money box is connected to another electric money boxes via the network connection.

According to some embodiments of the invention, the processor is configured to record data about a transaction.

According to some embodiments of the invention, the user interface is configured for entry of a dedication.

According to some embodiments of the invention, the dedication appears on the display.

According to some embodiments of the invention, the dedication is displayed remotely.

According to an aspect of some embodiments of the invention, there is provided a method for use of an electronic money box, the method including: advertising multiple charity campaigns on a display of an electronic money box; selecting a campaign of a plurality of charity campaigns; depositing a cash donation into the box to aid particular campaign.

According to some embodiments of the invention, the selecting is by depositing the cash while the particular campaign appears on the display.

According to some embodiments of the invention, the selecting is via a user interface.

According to some embodiments of the invention, the user interface is native to the money box.

According to some embodiments of the invention, the user interface includes a user interface of a device of a donor transmitted to the money box via at least one of a network and a wireless connection.

According to some embodiments of the invention, the method further includes recording an amount donated with the user interface.

According to some embodiments of the invention, the method further includes detecting an amount of cash contributed with a sensor of the electronic money box.

According to some embodiments of the invention, the method further includes reporting a donation to the electronic money box through a network connection to at least one of: a financial institution, a monetary account of a charity, a monetary account of an individual, additional electric money boxes, and an internet site of the charity campaign.

According to some embodiments of the invention, the method further includes connecting the electric money box to a user computing device through a wireless connection selected from: a cellular network, satellite network, Wi-Fi, Bluetooth, near field communication system, or any combination thereof.

According to some embodiments of the invention, the method further includes using the electric money box to make an electronic donation to one of the plurality of campaigns.

According to some embodiments of the invention, the electronic donation is made from a debit card, credit card, or financial mobile application.

According to some embodiments of the invention, the method further includes entering a dedication along with the donation.

According to some embodiments of the invention, the entering is via a user interface.

According to some embodiments of the invention, the user interface is native to the money box.

According to some embodiments of the invention, the user interface includes a user interface of a device of a donor transmitted to the money box via at least one of a network and a wireless connection.

According to some embodiments of the invention, the method further includes displaying the dedication on at least one of: the display, displays of linked devices, an internet page, as a notification to a personal computing device, or a combination thereof.

According to some embodiments of the invention, the method further includes distributing cash donations to the electronic money box proportionally according to recorded amounts for cash contributions to each of the plurality of charity campaigns.

According to some embodiments of the invention, the method further includes distributing cash donations to the electronic money box proportionally to a number of cash contributions to each of the plurality of charity campaigns.

According to some embodiments of the invention, the method further includes distributing cash donations to the electronic money box to a manager of the box according to agreements with plurality of charity campaigns.

According to some embodiments of the invention, the method further includes distributing cash donations to the electronic money box according to an amount of time each of the plurality of charity campaigns was displayed.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the figures:

FIG. 1: A schematic diagram illustrating an electronic money box, in accordance with some embodiments.

FIG. 2: A block diagram illustrating an electronic money box, in accordance with some embodiments.

FIG. 3: A flow chart illustrating a method of use of an electronic money box, in accordance with some embodiments.

FIG. 4: A flow chart illustrating a method of use of an electronic money box, in accordance with some embodiments.

FIG. 5: A block diagram of an electronic money box, in accordance with some embodiments.

FIGS. 6A-C: Schematic diagrams illustrating exemplary electronic money boxes, in accordance with some embodiments.

FIG. 7: A flow chart illustrating a method in accordance with an optional embodiment of the current invention.

FIG. 8: A flow chart illustrating a method in accordance with an optional embodiment of the current invention.

### DESCRIPTION OF SPECIFIC EMBODIMENTS

The present invention, according to some embodiments thereof, relates to an electronic money box and, more particularly, but not exclusively which may be designed for the purpose of donating charity and/or saving money and/or investing and/or transferring funds.

### OVERVIEW

An aspect of some embodiments of the current invention relates to an electronic money box is disclosed and described. Optionally, the electronic money box may be designed for the purpose of giving charity and/or saving money and/or investing and/or transferring funds.

An embodiment of the current invention may be an electronic money box which may have various functions. Some embodiments may be designed for donating charity and/or for saving money and/or for paying for things and/or other transfers of money. According to some embodiments, the electronic money box may be a charity box, savings box, piggy bank, safe, etc. Optionally, the system may include a depository for cash and/or promissory notes. For example, there may be a deposit slot to the depository. Optionally, the depository includes an enclosed space and/or a deposit slot configured to facilitate depositing items while inhibiting their removal and/or a locked access passage (e.g., a locked door) for removing contents. For example, the lock may be mechanical (e.g., opened via a key and/or combination). Alternatively, or additionally, the lock may be opened by biometric identification and/or via an application on a predesignated secondary device (e.g., a cellular phone, tablet, laptop, etc.).

According to some embodiments, the electronic money box may be a charity box. Optionally, the electronic money box may be a personal charity box. Optionally, a user who owns the electronic money box, and/or the location of the electronic money box (e.g., house, shop, office, etc.) may select what to do with the money. Optionally, the electronic money box may be a dedicated charity box e.g., distributed and/or collected by a particular charity, wherein the money goes to that particular charity. Optionally, there may be a division of control between people who donate, and/or the charity and/or the owner of the location and/or electronic money box. Optionally, a donor may specify through a user interface to whom their money should be directed (e.g., the electronic money box may include a few choices of charities). Optionally, a donor may specify a recipient for their donation.

According to some embodiments, a third party (not the donor or the location owner) may own and/or run one or more charitable collections using the electronic money box. Optionally, the third party may be an overriding authority. Optionally, the third party may facilitate donation to multiple charities using the same electronic money box. Optionally, the third party may advertise various charity campaigns at different times. Optionally, the third party may advertise on a display of the electronic money box. Optionally, the third party may advertise electronically on a display of the electronic money box. Optionally, the display may be included in the user interface. Optionally, the user interface may include a touch screen. Optionally, the user interface may be configured to facilitate advertising of various charity campaigns and/or donation to various charity campaigns electronically.

According to some embodiments, the electronic money box may include a safe and a housing. Optionally, the housing may include a slot for putting in money and/or an electronic interface.

Alternatively, or additionally, the electronic money box may include a display e.g., to show user input, to receive user input, to display data. Optionally, the display may show a user the status of the contents of the electronic money box. Optionally, the display may be a touch screen. Optionally, the electronic money may include one or more buttons to perform various functions.

According to some embodiments, the electronic money box may include an input interface. Optionally, a user may use the input interface to tell the electronic money box the value of the money that is being donated. Advantageously, instead of expensive bill and/or coin recognizing hardware, a user may insert money through a slot and/or credit card reader and/or financial mobile application. Optionally, a user may input through the input interface the amount of money inserted into the electronic money box. Optionally, the input interface may be a native interface. Optionally, the input interface may be a mobile application, e.g., a donor's cellular phone may be in communication with an electronic money box wirelessly (e.g., through a cellular network, satellite network, Wi-Fi, Bluetooth, etc.).

According to some embodiments, the user interface may be an app on a personal computing device. Optionally, the user interface may be a scannable code which may be configured to facilitate connection to a secure internet site configured to receive donations, e.g., barcode, QR code, etc. Optionally, the user interface may be a car reader associated to a display, etc. Optionally, various other electronic payment methods (such as, PayPal, Google pay, Bit, etc.) may be used to transfer donations to and/or via the electronic money box. Optionally, the system may allow a user to donate electronically to any of a variety of causes at any time (for example, there may be a user interface [e.g., a touch screen, a set of buttons etc.] to designate a selected cause of the currently available causes and/or campaigns). Additionally, or alternatively, the payments may be synchronized to the display e.g., when a user pays the system, the payment is credited to the currently displayed campaign.

According to some embodiments, the electronic money box may include a processor. Optionally, the processor that may keep track of how much money is in the box. Optionally, the processor may include a connection to an external network such as the internet, a cellular network, satellite network, LAN, Wi-fi, Bluetooth, etc. or a combination thereof. Optionally, the electronic money box may connect to a mobile application that may work in conjunction with the box. Alternatively, or additionally, there may be a means (e.g., a mobile application) for users (e.g., donors, owners, users, collectors, etc.) to monitor the status of the contents of the electronic money box.

According to some embodiments, the electronic money box (e.g., a charity box) may have a dual functionality. Optionally, an electronic money box may be designed to collect coins and/or bills and/or charge a credit card and/or charge a financial mobile application. Optionally, the electronic money box may allocate the collected funds directly to a recipient e.g., charity, financial institution, third party, etc. Optionally, funds (cash and/or electronic currency) may be earmarked by the user to a particular campaign (e.g., the campaign currently displayed on the display and/or by selecting a campaign from user interface. Optionally, the electronic money box may return coins and/or bill and/or change.

According to some embodiments, cash contributions may be negligible in comparison to the electronic contributions. Optionally, the cash functionality of the system may encourage users to donate. Optionally, the system may be configured to receive cash for a selected charity campaign. Optionally, the system may be configured to show and/or prove that the money is donated to the selected charity.

According to some embodiments, cash contributions may be sorted e.g., may direct cash to different internal compartments in accordance with the user's selected campaign. According to some embodiments, the cash may not be sorted but may enter a shared reservoir. Optionally, the system may include a money reader (e.g., the system may recognize bills and/or coins based on size, weight, optical characteristics etc.). Optionally, the system may record how much cash was donated to each cause. Optionally, each cause may receive cash according to the account recorded. Optionally, the cash may be divided proportionally to the reported amounts for the various causes. Optionally, a donor may be asked how much was donated and the cash may be divided proportionally to the reported amounts for the various causes. Optionally, the cash may be divided proportionally to the reported amounts for the various causes, even if the actual amount does not correspond to the sum of the reported amounts (e.g., after weeding out unreasonable outliers). Optionally, the cash may be divided proportionally to the reported amounts for the various causes, even if the actual amount does not correspond to the sum of the reported amounts and/or according to agreements between the various causes. Optionally, the cash may be divided by the number of donors contributing to each cause (for example, a sensor may sense when a donation is made and/or a processor may record how many donations were made while a certain cause was being advertised). Optionally, the cash may be divided by the number of donors contributing to each cause without accounting for the particular size of each donation (e.g., if there are 100 dollars to two causes, 1 with 20 donors 2nd with 60 donors, the first will receive 25% and the second will receive 75%). Optionally, the cash may be divided by some other estimation e.g., in proportion to electronic donations. Optionally, the cash may be divided equally without regard to number or kind of donations. Optionally, the cash may be divided according to the quantity of time each organization advertised. Optionally, the cash may be divided according to how much each organization paid for advertising space (e.g., paying more means more time, better times and better locations therefore expecting more donations). Optionally, the cash may not be divided e.g., part of the agreement of payment for the service is that each of the causes will pay all of their cash donations to the company running the campaign for its services while electronic donations may be given to the campaign.

According to some embodiments, electronic contributions may be sorted e.g., may direct electronic contributions in accordance with the user's selected campaign/s. According to some embodiments, electronic contributions may not be sorted but may be stored on a memory storage device. Optionally, the system may record how much money was donated to each cause. Optionally, each cause may receive electronic contributions according to the account recorded. Optionally, the electronic contributions may be divided proportionally to the reported amounts for the various causes. Optionally, a donor may be asked how much was donated and the electronic contributions may be divided proportionally to the reported amounts for the various causes. Optionally, the electronic contributions may be divided proportionally to the reported amounts for the various causes, even if the actual amount does not correspond to the sum of the reported amounts (e.g., after weeding out unreasonable outliers). Optionally, the electronic contributions may be divided proportionally to the reported amounts for the various causes, even if the actual amount does not correspond to the sum of the reported amounts and/or according to agreements between the various causes. Optionally, the electronic contributions may be divided by the number of donors contributing to each cause. Optionally, the electronic contributions may be divided by the number of donors contributing to each cause without accounting for the particular size of each donation (e.g., if there are 100 dollars to two causes, 1 with 20 donors 2nd with 60 donors, the first will receive 25% and the second will receive 75%). Optionally, the electronic contributions may be divided by some other estimation e.g., in proportion to cash donations. Optionally, the electronic contributions may be divided equally without regard to number or kind of donations. Optionally, the electronic contributions may be divided according to the quantity of time each organization advertised. Optionally, the electronic contributions may be divided according to how much each organization paid for advertising space (e.g., paying more means more time, better times and better locations therefore expecting more donations). Optionally, the electronic contributions may not be divided among campaigns, e.g., each electronic money box may be dedicated to a particular cause.

According to some embodiments, the electronic money box may facilitate receipt of a donation via electronic contributions (e.g., credit card, debit card, mobile payment, etc.) at the same time as cash. Optionally, the system may include interchangeable displays for donating to one or more different associations electronically and/or with cash. Optionally, at least a portion of the funds collected (e.g., the cash only, electronic contribution only, a portion of the cash and the electronic contribution) received by the system may be used to cover the operating costs of the system and/or advertisements and/or banking fees, etc. Optionally, such fees may be paid in addition to a fixed price for service.

According to some embodiments, the user interface may include an option to select an amount donated in cash and/or electronically. Optionally, such a selection may facilitate division of the funds to several different associations according to the available campaigns. Optionally, the user interface (e.g., local and/or wireless and/or Internet) may easily open a campaign and/or send a donation with a dedication.

According to some embodiments, the system may include an opening. Optionally, the opening may be configured to receive a donation. Optionally, the opening may be configured to open in order to receive a donation. Optionally, the opening may be configured to detect the proximity of a user and/or electronic device and/or cash to the opening. Optionally, the opening may be configured to open upon detection of the proximity of a user and/or electronic device and/or cash to the opening. Optionally, the opening may include a cover. Optionally, detection may be by one or more sensors.

According to some embodiments, the system may be configured to detect the entry of a donation, the system may be configured to detect the entry of a donation with and/or without cash identification. Optionally, the system may be configured to encourage the donor to donate and/or to increase their donation and/or to thank the donor for their donation upon detection of the donor's proximity and/or on entry of a donation to the system.

According to some embodiments, the electronic money box may include one or more programmable sounds which may automatically play and/or may be controlled remotely (e.g., by the user and/or the charity), for example, a rewarding sound may be played when money is inserted, etc.

According to some embodiments, an electronic money box may be programmed to allow one touch billing of a contribution by a credit card. Optionally, the one touch charging may include a child proof feature, for example two buttons that must be pressed simultaneously to make the charge. Optionally, small donation switches may be situated close to the electronic money box may facilitate transferred of a donation (e.g., similar to an Amazon dash button).

According to some embodiments, the electronic money box may include a quick control (e.g., control button with pre-programmed functionality) to easily donate a pre-determined donation. Optionally, the electronic money box may include child proofing for the quick control.

According to some embodiments, child proofing the electronic money box may include activating a feature of the electronic money box (i.e., electronic donation, etc.) which may Optionally, require simultaneously pushing two buttons distant from each other and/or another action which might be difficult for a child perform. Optionally, at least one of the buttons may be on a top surface (e.g., so that the force of pushing the buttons may be transferred to the surface on which the electronic money box sits such as since the electronic money box may not be very heavy, if a button on the side of the electronic money box pushing the button may push the electronic money box across the surface).

Alternatively, or additionally, a button may require a large surface to touch it (e.g., a child's finger may be too small), such as a capacitive button etc. Optionally, a passcode may be required. Optionally, a specific series of actions may be taken, such as buttons must be pushed, a button may be required to be turned and then pressed and/or other functions that a child may not know about and/or may not be able to do. Optionally, the electronic money box may provide a list of instructions which must be carried out which the child may not be able to read. Alternatively or additionally, there may be two or more buttons that need to be pushed (e.g., simultaneously) optionally the buttons are distanced in a way which would be difficult for a child to push simultaneously (e.g., due to the distance between them) and/or buttons may need to be pressed in a particular sequence and/or combination that would be difficult to perform without being told the combination.

According to some embodiments, the system may facilitate dedication of a donation, e.g., in their name, in the name of a loved one, in honor of a special event, etc. Optionally, the system may facilitate communication between various electronic money boxes, e.g., a dedication entered on one electronic money box may be displayed on multiple electronic money boxes. Optionally, the dedication may be in the form of text, and/or emojis, and/or images, and/or music, and/or an audio recording. Optionally, the dedication may be entered through a user interface. Optionally, the dedication may be entered through a local user interface. Optionally, the dedication may be entered using an external device (e.g., wirelessly, and/or Bluetooth, and/or an internet connection through a donor's personal computing device). Optionally, a user may specify where the dedication appears, e.g., on the local display, and/or on other displays of the system, and/or displays of other linked devices, and/or on an internet page (e.g., the campaign page of the charity), and/or as a notification to one or more personal computing devices, etc. Optionally, the point of sale (POS) display may be duplicated on other external screens that are close to the point-of-sale display. For example, the dedication may be entered on a local user interface and the user may select to display the dedication on multiple displays in the neighborhood. Optionally, the areas available for display may be selected in accordance with the amount donated.

There are various challenges that may occur in collecting charity boxes. A recipient representative (e.g., charity collector) may not know how much money is in the charity box and/or on some occasions a charity collector may go out of their way and/or use their time and/or resources to collect the electronic money box which may not have much money in it. In such a case seemingly, it would have been more worth the charity collector's time to collect an electronic money box form an alternative location and/or do something else more worthwhile for the charity organization. For example, an organization may pay a charity collector 10 dollars per hour. One day the charity collector goes to collect an electronic money box from a supporter, but it takes him 2 hours to get to the supporter and/or when he comes to the supporter, he finds only 10 dollars in the electronic money box. In such a case it would not have been worth the expense.

Alternatively, or additionally, according to some embodiments, a recipient representative (e.g., a charity collector, etc.) may wish to have an efficient way to collect money and/or communicating with the donors on the status of the money they set aside.

According to some embodiments, the money box may include a display on which the amount of money entered, transferred thereto and/or contained within may be shown. Optionally, the total amount of money may be displayed upon a command from a user. For example, a charity and/or an organization may supply supporters with an electronic money box which they may keep in their house and/or office and/or shop, etc. and an organization may from time to time come to collect the money that has accumulated in the electronic money box.

According to some embodiments, the amount of money in the electronic money box could advantageously be displayed. Optionally, the total amount of money in the electronic money box may be displayed on command. Optionally, the amount of money may be reported to a charity collector prior to their arrival on-site, e.g., to prevent waste of time and/or resources. Optionally, the status of the electronic money box may be checked remotely e.g., a charity collector may remotely check how much money is the box, etc. Optionally, once a pre-determined threshold amount is met, a report may be sent to a charity collector, e.g., to come and collect the money. Optionally, the report may be made by the user e.g., a user may check the total of money in the electronic money box daily, weekly, monthly, etc. Optionally, the electronic money box may report the total of money in the electronic money box to the charity collector and/or charity organization through a network, e.g., internet, a cellular network, satellite network, LAN, Wi-fi, Bluetooth, etc., or a combination thereof. Optionally, the electronic money box may report the total of money in the electronic money box to the charity collector and/or charity organization automatically after a pre-determined period, e.g., daily, weekly, monthly, etc. For example, collection may include the collector and/or electronic money box notifying the box owner that it is time to pay and/or the box owner may transfer money (e.g., via bank transfer, credit card etc.) to the charity and/or collect any money in the box.

According to some embodiments, a user may wish to, over time, accumulate money and/or then transfer the accumulated funds to a recipient, e.g., a person and/or an organization and/or a bank account and/or an investment, etc. For example, a user may wish to accumulate a few coins each day and/or a few bills each day, such as their small change, tips, a fixed amount, left over monies from a budgeted amount, money earned, etc.

According to some embodiments, an electronic money box may be used to track money between different accounts and/or organizations. For example, a user may put money in the box and/or transfer money via the user interface between his account and that of a charity and/or a family member. Optionally, the user may be identified by the device. For example, the user may be identified by a passcode and/or by a biometric device and/or the user may use a personal computing device to identify himself. Optionally, the box may store money and/or automatically make transfers and/or periodically make transfers and/or periodically tell a user to make a transfer and/or notify a user when money is credited to him and/or debited. According to some embodiments the box and/or associated application may keep track of who owes what to whom without transferring funds. Additionally, or alternatively, the box, user interface and/or application may supply a convenient interface to get money and/or transfer money according to the recorded accounts. For example, the box may serve as a group bank and/or a way for a group to track and transfer money. For example, a family may keep money in a single account and/or keep track of the money and/or access it via the box and/or associated application. According to some embodiments, the box and/or application may be used remotely (e.g., by a user over his personal computing device [e.g., smartphone, tablet, personal computer etc.]). For example, the box may be used to encourage children to save money. For example, a parent may keep track of how much money a child has deposited and/or give to the child encouragement. Optionally, the child may make deposits and/or withdrawals. Optionally, the parents will control and/or be notified of activities (e.g., deposits/withdrawals). Thus, the box may be used as an educational device to help train children to handle money properly and/or responsibly.

Alternatively, or additionally, according to some embodiments, a user may wish to save money over time and/or to monitor the contents of the savings box. Optionally, a user may wish to have a transfer system for transfer of funds once money has accumulated in the savings box. Optionally, a user may wish to invest the money accumulated in the savings box. For example, a user may wish to invest extra money in a trust fund and/or a stock and/or from time to time, a user may set aside money for this. Optionally, the savings box may be configured to communicate with an external financial service provider, e.g., over a network such as the internet, a cellular network, satellite network, LAN, Wi-fi, Bluetooth, etc., or a combination thereof.

Alternatively, or additionally, according to some embodiments, a user may wish to save money in a safe. Optionally, a user may put money into the safe, which may keep a record of the amount saved. Optionally, a user may transfer an amount of money to a safe virtually. Optionally, the virtual amount of money may be transferred to a user's bank account. Optionally, the virtual amount of money may be transferred over a network such as the internet, a cellular network, satellite network, LAN, Wi-fi, Bluetooth, etc. or a combination thereof. For example, a child may wish to save their pocket money in a piggy bank. The child's parent may then take the money out of the piggy bank and transfer the saved amount to a bank account. The piggy bank may keep a record of the amount of money saved and/or transferred.

According to an aspect of some embodiments of the invention, there is provided an electronic money box including: a cash depository within a housing of the box including a money insertion slot leading from outside the housing into the cash depository; a processor configured for identifying cash deposits to the depository, recording cash deposits and electronic contributions, reporting an amount of money in the depository, and reporting an amount of money owed to a recipient of the cash contributions and the electronic contributions; a user input interface including a quick control for donating a predetermined electronic contribution; and an output interface configured to report to a user: the cash deposits, the electronic contributions, the amount of money in the depository and the amount of money owed to a recipient of the cash contributions and the electronic contributions.

According to some embodiments, the electronic money box may include a cash depository within a housing of the box including a money insertion slot leading from outside the housing into the cash depository, a processor configured for identifying cash deposits to the depository, and/or recording cash deposits and electronic contributions, and/or reporting an amount of money in the depository, and/or reporting an amount of money owed to a recipient of cash contributions and electronic contributions, and/or to execute and/or record a monetary transaction. Optionally, the electronic money box may include a user input interface e.g., a quick control for donating a predetermined electronic contribution. Optionally, the electronic money box may include an output interface configured to report to a user, e.g., cash deposits, electronic contributions, amount of money in a depository, amount of money owed to a recipient of cash contributions and/or electronic contributions. Optionally, the electronic money box may include a child proof system. Optionally, the electronic money box may include a network connection. Optionally, the electronic money box may be connected to at least one of a financial institution, and/or a monetary account of a charity, and/or a monetary account of an individual, through a network.

Some embodiments relate to a method for using an electronic money box including depositing cash to the electronic money box by inserting cash through a money slot into a depository, and/or depositing electronic funds and recording the deposit/s in an electronic database. Optionally, the system may report the value of the deposit via a user input interface. Optionally, depositing electronic funds may be by charging a credit card and/or financial mobile application. Optionally, the electronic money box may include a network interface. Optionally, electronically transferring money to a recipient via the network interface may update an electronic database in accordance with the amount of money electronically transferred. Optionally, the transferring may occur when a pre-determined threshold amount is reached. Optionally, the system may confirm completion of a transfer of the money to a recipient. Optionally, the system may report to a recipient when a pre-determined threshold amount is reached.

### SPECIFIC EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to the figures.

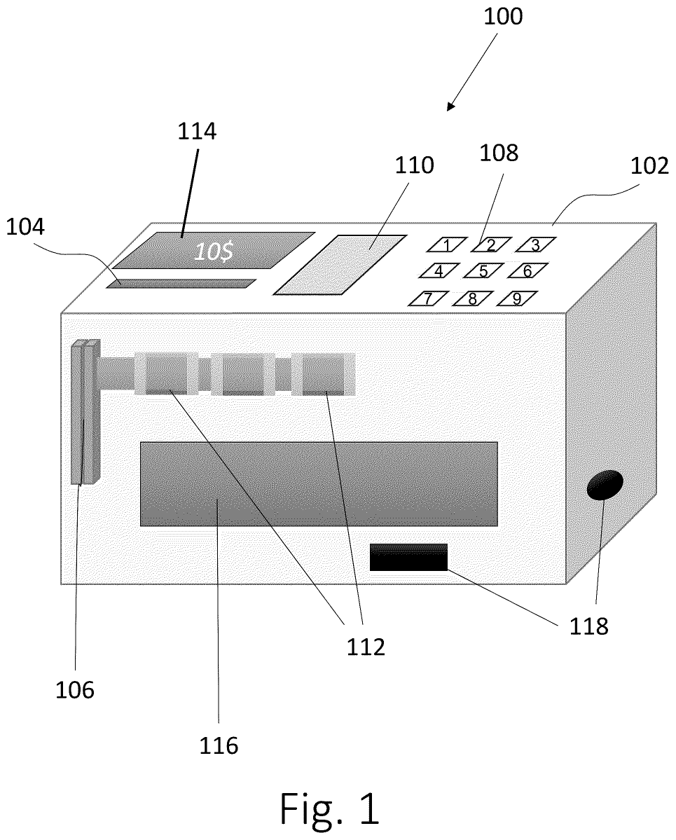

FIG. 1 is a schematic diagram illustrating an electronic money box, in accordance with some embodiments. For example, the electronic money box 100 may include a housing 102 and a safe (not shown). Housing 102 may include one or more money slots 104, credit card reader 106, and/or additional money insertion or transfer sites. Housing 102 may include one or more user input interfaces, such as a keyboard 108, touch screen 110, control buttons 112, etc. Optionally, housing 102 may also include a contents screen 114 (e.g., a touch screen and/or a display screen) and an electronic money box opening 116, through which the safe may be accessed, and/or change provided.

According to some embodiments, a child proof feature, such as child safety buttons 118 may be included. For example, a quick contribution may be disabled until the child safety buttons 118 are properly pushed. The child may not know that the push the buttons may need to be pushed in a particular order and/or simultaneously and/or a switch may be configured such that it would be difficult (e.g., due to the size of the child's hand and/or finger and/or the strength of their grip, etc.) for a child to activate. For example, two buttons may be positioned sufficiently far apart that it would be difficult to push them together with a small hand and/or positioned where it is difficult to place two hands together.

Alternatively, or additionally, when a donation is made, the system may notify a personal computing device of the user for approval. The transaction may be prevented until the user approves using their device. Alternatively, or additionally, a user may know what was deposited, and/or when, and/or whether it was approved and/or may inhibit further donations.

According to some embodiments, the electronic money box may include a housing and/or a safe. Optionally, the housing and/or safe may be of various sizes. Optionally, a housing and/or a safe may range in volume from between about 0.1 liter to about 1 liter of space, and/or between about 1 liter to about 10 liters of space, and/or between about 10 liters to about 100 liters of space, etc. Each possibility is a separate embodiment.

According to some embodiments, the electronic money box may include an opening (e.g., a slot) which may be designed for inserting money. Optionally, the electronic money box may include an opening which may be designed to insert and/or remove money from the electronic money box. Optionally, an opening in the electronic money box may include a locking system.

According to some embodiments, the electronic money box may include a processor. Optionally, the processor which may have a function and/or various functions. Optionally, the processor may keep a record of various status details, for example, how much total money is in the electronic money box, history of money inserted into the electronic money box, what coins and/or bills and/or checks are inside the electronic money box, how much money was transferred electronically to the system, how much of each currency, etc. Optionally, the processor may include a record of the donors and/or the amount donated by each donor.

According to some embodiments, the electronic money box may include a display which may present to a user various detail about the contents of electronic money box, for example, how much total money is in the electronic money box, history of money inserted into the electronic money box, what coins and/or bills and/or checks are inside the electronic money box, how much money was transferred electronically to the system, how much of each currency, etc.

According to some embodiments, the electronic money box may include a coin and/or bill and/or check detection function. Optionally, the detection function and/or device may be preset for a certain country and/or multiple countries' currency and/or a user and/or the software of the system may be programmed to identify various currencies. Optionally, the electronic money box may detect the diameter and/or width and/or weight of a bill and/or coin. For example, the processor may be programed to recognize when a coin of a particular size is inserted, and it may then count it as the desired coin. Optionally, other functions may be programmed by the user and/or a technician and/or may be preset. Optionally, there may be an option for a user to manually enter the value of what is inserted into the electronic money box. For example, there may be a keyboard and/or number board buttons that a user may record how much the bills and/or checks and/or coins are and/or there may be a button that corresponds to a certain bill and/or coin and/or on putting money in the electronic money box the user may press the button to inform the system.

According to some embodiments, the electronic money box may include a credit card reader and/or may be connected to a server that may connect to a credit card service. Alternatively, or additionally, the system may save credit card details of a user. Optionally, a predetermined quick contribution may be made by means of an electronic payment (e.g., a predetermined quick contribution may be made when a credit card is swiped through a reader and/or exposed to a near field communication (NFC) payment system and/or upon exposure to a code (e.g., a QR code) of an electronic payment system.

According to some embodiments, the electronic money box may include a passcode and/or a lock. Optionally, the passcode and/or the lock may be required to use some and/or all the functions of the processor. For example, this may help prevent tampering from children and/or thieves. Optionally, some and/or all the functions of the electronic money box and/or processor and/or programing may include a form of tamper proofing (e.g., prevention of child tampering.). Optionally, a quick contribution may be disabled until the child tamper prevention is released. For example, a credit card reader and/or a code reader and/or a quick control may be disabled until the child tamper prevention is released.

According to some embodiments, the electronic money box may include a control button and/or multiple buttons. Optionally, one or more control buttons may be programed for different functions. For example, a control button may be programed, such that each time it is pushed and/or pushed in specific way, a certain fixed and/or manually selected amount of money may be billed (e.g., for a credit card, debit card, and/or bank account, etc.) and/or may be scheduled to be billed at a future date. For example, this may enhance ease for a user since the user may not be required to enter physical money and/or scan their credit card, rather the user may just push a button to bill their account automatically.

According to some embodiments, the electronic money box may accept and/or count coins. Optionally, if a coin is not recognized, then it may be given a default value and/or listed as an unknown coin (e.g., of a certain size) and/or may ask the donor to specify the coin's value.

According to some embodiments, the electronic money box may accept bills. Optionally, the money box may not recognize bills (e.g., this may save money on recognition technology). Optionally, the electronic money box may count the bills as a default value and/or the user may be asked to input a value for a bill. For example, a speaker may broadcast an oral request, “please input the value of the inserted bills” and/or the request may appear on a view screen of a user output interface, etc.

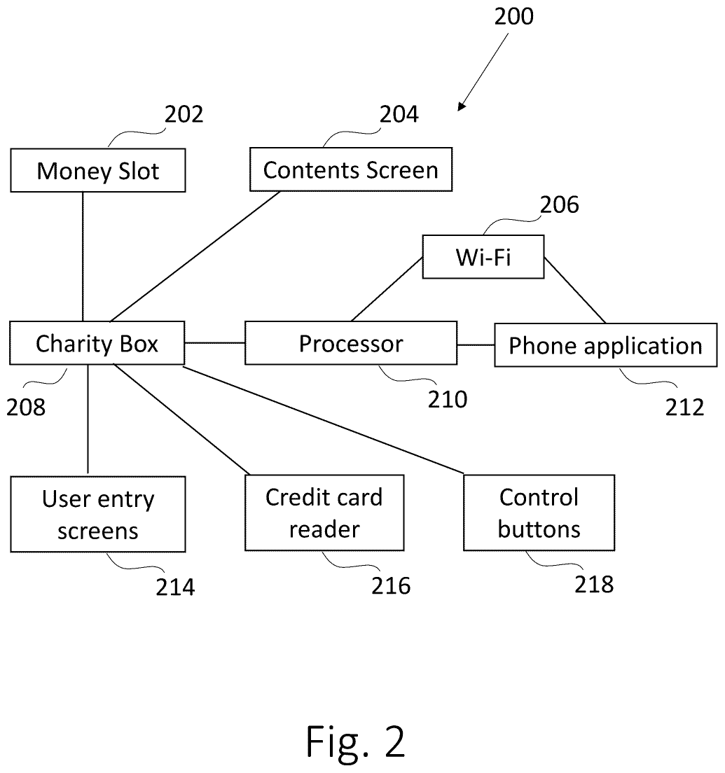

FIG. 2 is a block diagram illustrating an electronic money box, in accordance with some embodiments. For example, the electronic money box 200 may be a charity box 208, which may include a money slot 202 and/or one or more user entry screens 214 and/or keyboards, and/or a credit card reader 216 and/or one or more control buttons 218. Charity box 208 may include a processor 210, which may connect by Wi-Fi 206, to a user program and/or mobile application 212 and/or a charity collector program. The electronic money box 100 may include an IUT (e.g., a Sim card) and/or may use Bluetooth and/or Wi-Fi to connect to an internet server and/or may connect to a mobile device. Electronic money box 200 may include a contents screen 204 which may display the amount of money inserted into the money slot and/or the total amount of money contained within the electronic money box and/or the amount of money transferred to the charity and/or box.

According to some embodiments, the electronic money box may include a mobile application and/or program that may be able to monitor the contents of the electronic money box and/or transfer money to and/or from the electronic money box and/or open and/or close the electronic money box and/or may include other controls. For example, an application may be able to show the user the details of the contents of the box, and/or a user may use the application to manually transfer the amount of money in the electronic money box and/or less to a desired charity and/or person and/or account etc. Once a user has transferred the money, they may remove the money from the electronic money box and take it. Optionally, money may be removed from the money box at any time, and/or after a pre-determined time and/or after a pre-determined amount of money has been collected. Optionally, an application may store the credit card information of the user and/or allow the user to transfer money with reduced clicks and/or the user may select a default charity and/or organization and/or account to which to transfer the money, etc. Optionally, a user may change the settings of to whom the money is sent. Optionally, a user may program an automatic transfer scheduled at a fixed time interval and/or may schedule a single and/or multiple future transfers. Optionally, when a transfer and/or payment is made, a user may receive a text message and/or email and/or notification of such. Optionally, an application may allow a user to donate remotely from the box. Optionally, there may be a dash button that can be placed in remote locations to make a donation. For example, a dash button may be placed near a door of a house so that the owner can trigger a fixed donation upon entering and/or leaving his home. Optionally, the remote control may include an interface to identify a user, payment means and/or quantity of a donation.

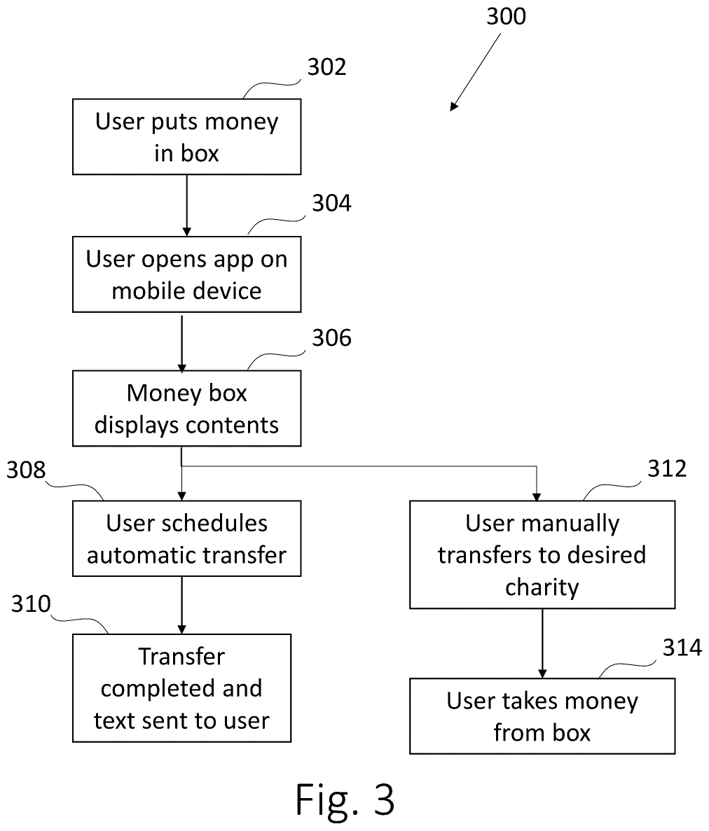

FIG. 3 is a flow chart illustrating a method of use of an electronic money box, in accordance with some embodiments. For example, in method 300, a user may insert 302 money into an electronic money box. The user may open 304 an app on their personal computing device (e.g., cellular phone, tablet, laptop, smart watch, smart glasses, VR, etc.). The money box app and/or a display on the housing may display 306 the contents of the electronic money box. A user may then use the app to schedule 308 automatic money transfers to and/or from the electronic money box. Once a transfer is complete, the app may send 310 a message to the user confirming completion of the transfer. Alternatively, a user may manually transfer 312 money to and/or from the electronic money box (e.g., to a desired charity, etc.). Optionally, an authorized user may take 314 the money out of the electronic money box (e.g., a charity collector, parent, etc.).

According to some embodiments, an electronic money box may include a mobile app and/or program designed for the charity collector who may be able to monitor the contents of the electronic money box and/or transfer money from the electronic money box and/or open and/or close the electronic money box and/or other controls.

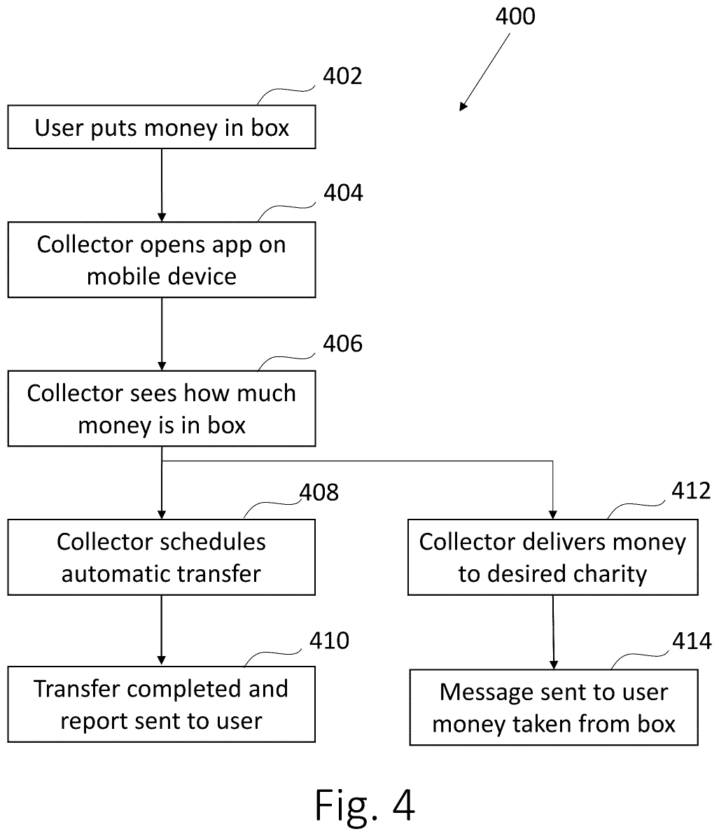

FIG. 4 is a flow chart illustrating a method of use of an electronic money box, in accordance with some embodiments. For example, in method 400, a user may insert 402 money into an electronic money box. A charity collector may open 404 an app on their personal computing device (e.g., mobile device) and be shown 406 how much money is in the electronic money box. The charity collector may then schedule 408 an automatic transfer, and when the transfer is complete, a text message may be sent 410 to the charily collector and/or user. Alternatively, a charity collector may schedule a visit to the electronic money box once the amount of money reaches a predetermined threshold. The charity collector may then manually retrieve the money and deliver 412 it to the desired charity. A text message may be sent 414 to the charily collector and/or user confirming receipt of the money by the charity.

According to some embodiments, an application may be able to show the charity collector the details of the contents of the box, and/or a charity collector may use the application to manually transfer the amount of money in the electronic money box a desired charity and/or person and/or account, etc. Optionally, a charity collector may send a request to a user requesting that they send money and/or approve the collection of money. On approval, the charity collector may bill the credit card, etc.

According to some embodiments, once a user has electronically transferred money, they may remove the cash from the electronic money box and take it for themselves. An application may store the credit card information of the user and/or allow the charity collector to transfer and/or collect money remotely. This may reduce the number of visits a charity collector may need to physically visit the donor and/or donation box. Optionally, an electronic money box may be programmed and/or preset to give to a default charity and/or organization and/or account to which to transfer the money, etc. Optionally, a user may change various settings, such as to whom the money is sent and/or the charity collector may then not be allowed to collect the money in the box. Optionally, a charity collector may program an automatic transfer scheduled at fixed time interval and/or may schedule a single and/or multiple future transfers. Once a transfer and/or payment is made a user may receive a text message and/or email and/or notification. Optionally, a screen on the electronic money box may receive messages and/or pictures from a charity collector and/or various potential collectors. For example, a charity may send to the user pictures and/or a message about recent activity in the charity and/or may sent to the user's mobile application, etc. and/or the charity collector may send a request to the user that may appear on the electronic money box screen and/or on the app and/or mail of the user.

According to some embodiments, the electronic money box may include a function that requires a charity collector to come into close proximity to the electronic money box and/or have a function to collect the funds with a mobile app.

According to some embodiments, a user may be able nullify collection and/or stop scheduled payments. Optionally, a user may set the program to give a certain budgeted amount of money to a charity collector and/or the program may alert the user when the budgeted amount has been reached and/or is close to reaching the budgeted amount.

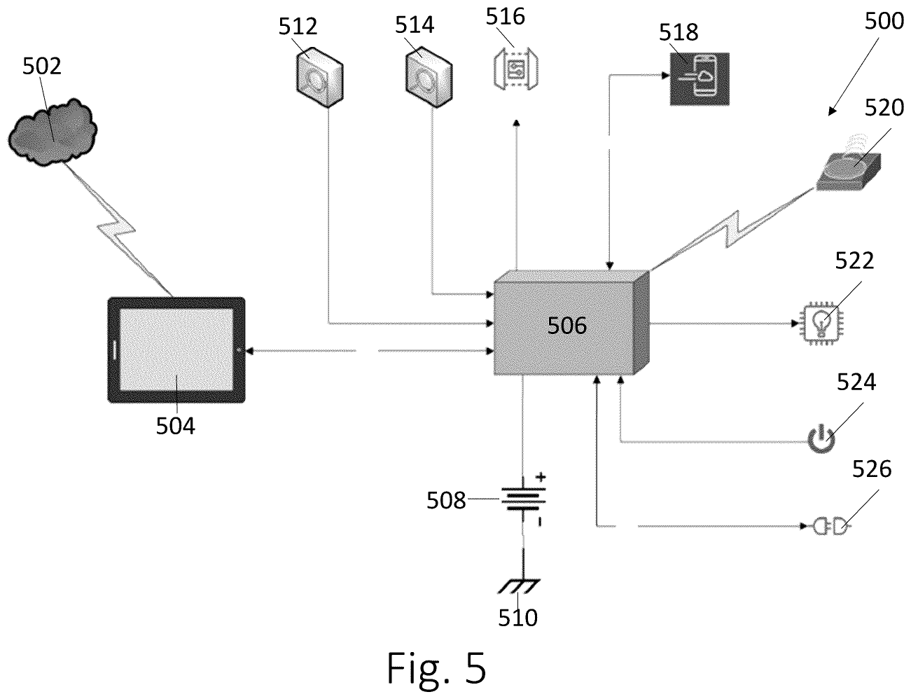

FIG. 5 is a block diagram of an electronic money box, in accordance with some embodiments. For example, electronic money box 500 may include a display 504 and a processor 506. Display 504 may be an electronic display and/or user interface. Display 504 may be connected to the internet 502, e.g., by wi-fi, Bluetooth, cellular network, satellite network, etc. Optionally, the display may include a tablet and/or a smartphone. Optionally, display 504 may include a touch screen. Optionally, display 504 may have a diagonal length ranging between about 5 cm to about 10 cm and/or between about 10 cm to about 15 cm, and/or between about 15 cm to about 20 cm. Optionally, processor 506 may be connected to a rechargeable battery 508 and/or a local electricity grid 510. Optionally, the system may include a sensor. For example, a proximity sensor 512 and/or an optical sensor 514 may be connected to processor 506. Optionally, proximity sensor 512 and/or optical sensor 514 may be located at and/or close to porthole 516 for bills and/or coins. For example, the proximity sensor may determine when money is dropped or is about to be dropped into the porthole. For example, the processor may give a command to open a cover of the hole in response to detecting a hand and/or money near the porthole. For example, the processor 506 may give a command to display an encouraging and/or commercial message is response to detecting a hand and/or money near the porthole. Optionally, the processor 506 will record when money is detected being placed in the porthole. For example, an optical sensor 514 may be used to detect and/or identify the value of money being placed in the porthole. For example, an optical sensor 514 may be directed toward a higher portion of the box (e.g., the money reservoir) and/or may be used to determine when a box is getting full and/or when to send a notification that the money should be collected. Optionally, processor 506 may include near field communication (NFC) payment facilities 518, Optionally, the system may include a means of remote tagging 520. Optionally, remote tagging 520 may take place through the internet, e.g., by wi-fi, Bluetooth, cellular network, satellite network, etc. Optionally, processor 506 may include one or more LED lights 522. Optionally, processor 506 may include an on/off switch 524. Optionally, one or more USB connections 526 may be connected to processor 506.

According to some embodiments, the processor may be configured for managing the energy system, reading sensors, activating mechanisms, electromechanical systems, activation of visual indicators, communication to wireless controls, internet Interface, display, etc. or any combination thereof. Optionally, the processor may connect to an NFC module for payment and/or may be based on a tablet with built-in NFC and/or an app. Optionally, the processor may include a wireless communication system as needed. For example, a wireless connection may be used by a user to report how much money he deposited and/or for what cause and/or to relay a dedication message and/or to instruct the system when and where to display the dedication message. Alternatively or additionally, a dedicated user interface may be used to report how much money he deposited and/or for what cause and/or to relay a dedication message and/or to instruct the system when and where to display the dedication message.

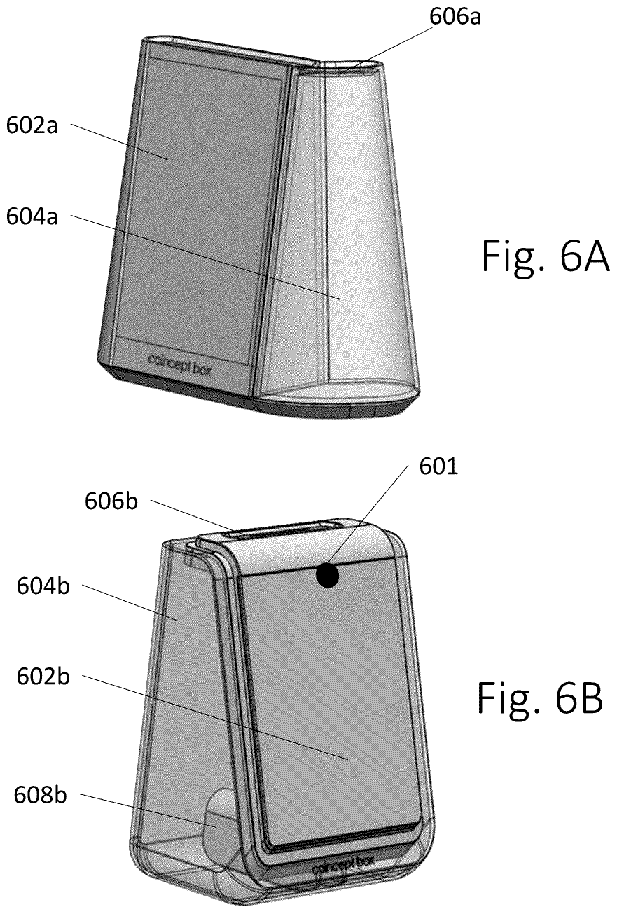

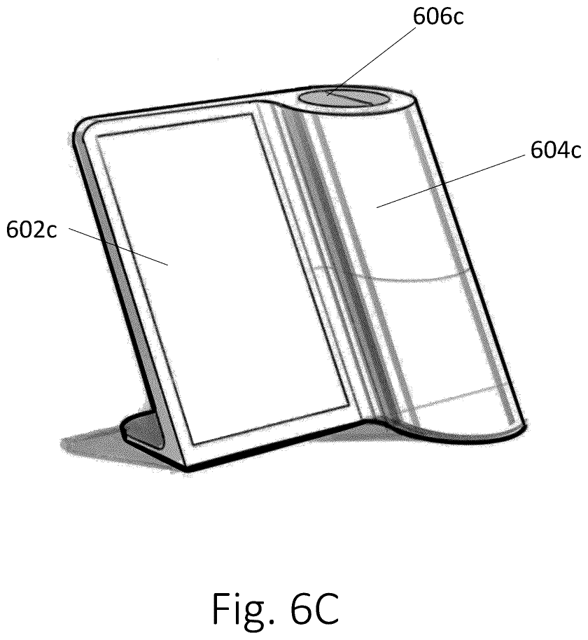

FIG. 6A is a schematic diagram illustrating and exemplary electronic money box, in accordance with an embodiment of the current invention. For example, the electronic money box may include a money slot 606a, a cash reservoir 604a and/or a display 602a. Optionally, the electronic money box may include a battery and/or be connected by a cord to a power grid.

Optionally, the money box may include a processor. For example, an accelerometer may register vibrations resulting from coins being inserted into the box. and/or sensors. In some embodiments, the coin reservoir 604a may be lit. Optionally, coin reservoir 604a may be transparent, and/or semi-transparent, and/or opaque, at least in part. Optionally, display 602a and/or reservoir 604a may be detachable. Optionally, display 602a may be built in. For example, the reservoir 604a of the embodiment of FIG. 6A has a curved cross section and/or tapered form (e.g., tapered upward) and/or is located beside the display 602a.

In some embodiments, the system may include a user interface. For example, display 602a may be a touch screen and/or a user may enter messages and/or report monetary donations and/or make dedications and/or make electronic donations using the touch screen. In some embodiments, the system may include a camera and/or proximity sensor that detects and/or confirms when a user comes close and/or when money is inserted into the money slot 606a and/or what currency and/or what denomination is inserted into the money slot 606a. The user interface may include a microphone and/or a speaker.

In some embodiments, the money box may include a processor and/or an Internet connection. For example, images and/or audio messages may be sent from via Internet for display on the display 602a and/or loudspeaker. For example, messages from a processor of the system and/or a user may be relayed by the system to various receivers over the web. For example, the system may inform a recipient when money is donated and/or a credit card company of a credit payment and/or may transfer a message (e.g., dedication) and/or information for a receipt.

FIG. 6B is a schematic diagram illustrating and exemplary electronic money box, in accordance with an embodiment of the current invention. For example, the electronic money box may include a coin slot, bill slot 606b, processor, cash reservoir 604b, and/or a display 602b. Optionally, the electronic money box may include a battery and/or be connected by a cord to a power grid. Optionally, coin reservoir 604b may be lit. Optionally, coin reservoir 604b may be transparent, and/or semi-transparent, and/or opaque, at least in part. Optionally, display 602b and/or reservoir 604b may be detachable. Optionally, display 602b may be built in. For example, in the embodiment of FIG. 6B, the reservoir 604b is located behind the display 602b. Optionally, display 602b may include a forward camera 601 and/or a rear camera [e.g., display 602b may be part of an existing cellular phone and/or tablet. Optionally, a detector (e.g., the forward camera 601) may be used to detect when a person approaches the display 602b. In some embodiments, a sensor (e.g., the rear camera, a microphone, an accelerometer, a magnetometer, a proximity) may be used to determine when and/or how much money is placed in the reservoir 604b and/or how much money is contained in the reservoir 604b. For example, the processor may include image processing software and/or software that integrates data from various sensors to determine whether, when and/or how much money is placed into the reservoir 604b. Optionally, the reservoir 604b includes a lock 608b. For example, lock 608b may be used to hold and/or release the display 602b to the reservoir 604b. For example, lock 608b may be used to inhibit and/or facilitate the system from a location (e.g., the system may be locked to a stationary object to prevent it from being stolen). Alternatively or additionally, local sensors may be used to protect the system from theft (for example, a camera 601 may be used to identify a thief and/or a GPS sensor and/or a location tag may be used to find the system after it has been taken away from a location where it was placed.

Optionally, the money box may include a processor. For example, an accelerometer may register vibrations resulting from coins being inserted into the box. and/or sensors. In some embodiments, the coin reservoir 604b may be lit. Optionally, coin reservoir 604b may be transparent, and/or semi-transparent, and/or opaque, at least in part. Optionally, display 602b and/or reservoir 604b may be detachable. Optionally, display 602b may be built in. For example, the reservoir 604b of the embodiment of FIG. 6B has a curved cross section and/or is located beside the display 602b. Optionally, reservoir 604b has an approximately prismatic form and/or is tapered (e.g., tapered upward). For example, the display 602b may form all or part of one of the sides of the reservoir 604b.

In some embodiments, the system may include a user interface. For example, display 602b may be a touch screen and/or a user may enter messages and/or report monetary donations and/or make dedications and/or make electronic donations using the touch screen. In some embodiments, the system may include a camera and/or proximity sensor that detects and/or confirms when a user comes close and/or when money is inserted into the money slot 606a and/or what currency and/or what denomination is inserted into a coin slot and/or the bill slot 606b. The user interface may include a microphone and/or a speaker.

In some embodiments, the money box may include a processor and/or an Internet connection. For example, images and/or audio messages may be sent from via Internet for display on the display 602b and/or loudspeaker. For example, messages from a processor of the system and/or a user may be relayed by the system to various receivers over the web. For example, the system may inform a recipient when money is donated and/or a credit card company of a credit payment and/or may transfer a message (e.g., dedication) and/or information for a receipt.

FIG. 6C is a schematic diagram illustrating and exemplary electronic money box, in accordance with an embodiment of the current invention. For example, the electronic money box may include a money slot 606c, a cash reservoir 604c and/or a display 602c. Optionally, the electronic money box may include a battery and/or be connected by a cord to a power grid.

Optionally, the money box may include a processor. For example, an accelerometer may register vibrations resulting from coins being inserted into the box. and/or sensors. In some embodiments, the coin reservoir 604c may be lit. Optionally, coin reservoir 604c may be transparent, and/or semi-transparent, and/or opaque, at least in part. Optionally, display 602c and/or reservoir 604c may be detachable. Optionally, display 602c may be built in. For example, the reservoir 604c of the embodiment of FIG. 6A has a curved cross section and/or cylindrical form (e.g., tapered upward) and/or is located beside and/or offset in front of the display 602a and/or angled backwards with the screen.

In some embodiments, the system may include a user interface. For example, display 602c may be a touch screen and/or a user may enter messages and/or report monetary donations and/or make dedications and/or make electronic donations using the touch screen. In some embodiments, the system may include a camera and/or proximity sensor that detects and/or confirms when a user comes close and/or when money is inserted into the money slot 606c and/or what currency and/or what denomination is inserted into the money slot 606c. The user interface may include a microphone and/or a speaker.

In some embodiments, the money box may include a processor and/or an Internet connection. For example, images and/or audio messages may be sent from via Internet for display on the display 602c and/or loudspeaker. For example, messages from a processor of the system and/or a user may be relayed by the system to various receivers over the web. For example, the system may inform a recipient when money is donated and/or a credit card company of a credit payment and/or may transfer a message (e.g., dedication) and/or information for a receipt.

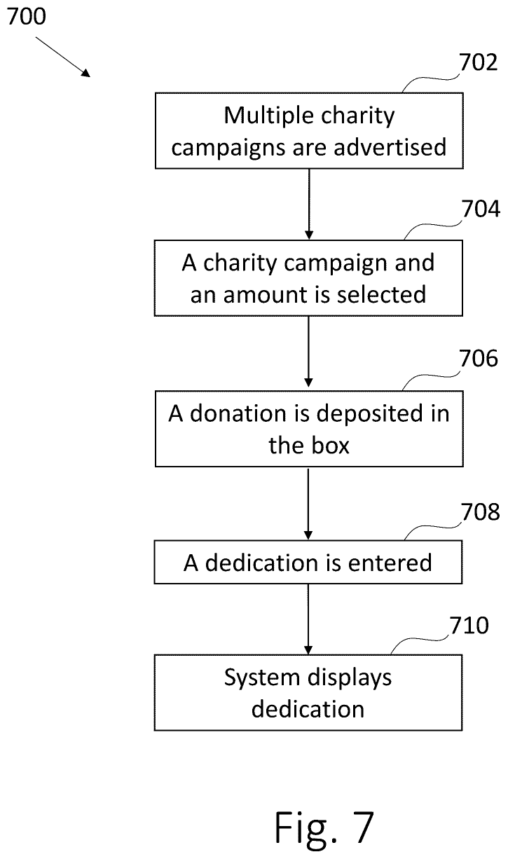

FIG. 7 is a flow chart illustrating a method in accordance with an optional embodiment of the current invention. For example, in method 700, an electronic money box may include a housing and/or a display. The display may advertise 702 multiple charity campaigns. The charity campaign and amount are selected 704 by the user. The donor deposits 706 a donation in the box. Optionally, the donation may be in cash (e.g., coins and/or bills) and/or may be an electronic contribution. The donor may enter a dedication 708. The system may display 710 the dedication.

According to some embodiments, the system may facilitate dedication of a donation, e.g., in their name, in the name of a loved one, in honor of a special event, etc. Optionally, the system may facilitate communication between various electronic money boxes, e.g., a dedication entered on one electronic money box may be displayed on multiple electronic money boxes. Optionally, the dedication may include text, and/or emojis, and/or still images, and/or moving images and/or music, and/or an audio recording. Optionally, the dedication may be entered through a user interface. Optionally, the dedication may be entered through a local user interface. Optionally, the dedication may be entered using an external device (e.g., wirelessly, and/or Bluetooth, and/or an internet connection through a donor's personal computing device). Optionally, a user may specify where the dedication appears, e.g., on the local display, and/or on other displays of the system, and/or displays of other linked devices, and/or on an internet page (e.g., the campaign page of the charity), etc. Optionally, the point of sale (POS) display may be duplicated on other external screens that are close to the point-of-sale display. For example, the dedication may be entered on a local user interface and the user may select to display the dedication on multiple displays in the neighborhood. Optionally, the areas available for display may be selected in accordance with the amount donated.

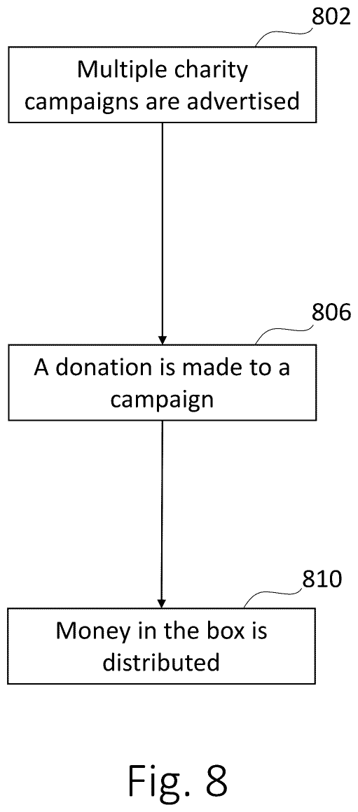

FIG. 8 is a flow chart illustrating a method in accordance with an optional embodiment of the current invention. For example, in the method, an electronic money box may include a housing and/or a display. The display may advertise 802 multiple charity campaigns. Optionally, a user may make a donation in cash (e.g., coins and/or bills) and/or electronically. The donor may enter a dedication. The system may display the dedication and/or transfer the dedication to be displayed elsewhere. Optionally, a user may use various means to make a donation 806 (e.g., scanning a link on the display to make a donation over his own computing device and/or using a local network to communicate donation information over a wireless link and/or using a preprogrammed quantity and/or payment method etc.). Additionally the donor may donate 706 cash into a reservoir.

According to some embodiments, cash contributions may be distributed 810 by various methods. For example, donations may be sorted e.g., may direct cash to different internal compartments in accordance with the user's selected campaign. According to some embodiments, the cash may not be sorted but may enter a shared reservoir. Optionally, the system may include a money reader (e.g., the system may recognize bills and/or coins based on size, weight, optical characteristics etc.). Optionally, the system may record how much cash was donated to each cause (e.g., according to a stipulation of the user on a user interface at the time of contributing and/or according to the cause displayed on the display at the time of the contribution. Optionally, cash may be distributed 810 according to the account recorded. Optionally, the cash may be distributed 810 proportionally to the reported amounts for the various causes. Optionally, a donor may be asked how much was donated and the cash may be distributed 810 proportionally to the reported amounts for the various causes. Optionally, the cash may be distributed 810 proportionally to the reported amounts for the various causes, even if the actual amount does not correspond to the sum of the reported amounts (e.g., after weeding out unreasonable outliers). Optionally, the cash may be distributed 810 proportionally to the reported amounts for the various causes, even if the actual amount does not correspond to the sum of the reported amounts and/or according to agreements between the various causes. Optionally, the cash may be distributed 810 by the number of donors contributing to each cause (for example, a sensor may sense when a donation is made and/or a processor may record how many donations were made while a certain cause was being advertised). Optionally, the cash may be distributed 810 by the number of donors contributing to each cause without accounting for the particular size of each donation (e.g., if there are 100 dollars to two causes, 1 with 20 donors 2nd with 60 donors, the first will receive 25% and the second will receive 75%). Optionally, the cash may be distributed 810 by some other estimation e.g., in proportion to electronic donations. Optionally, the cash may be distributed 810 equally without regard to number or kind of donations. Optionally, the cash may be distributed 810 according to the quantity of time each organization advertised. Optionally, the cash may be distributed 810 according to how much each organization paid for advertising space (e.g., paying more means more time, better times and better locations therefore expecting more donations). Optionally, the cash may not be distributed 810 e.g., part of the agreement of payment for the service is that each of the causes will pay all of their cash donations to the company running the campaign for its services while electronic donations may be given to the campaign.

These embodiments are provided by way of example and are in no means intended to limit the scope of the invention.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

### General

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are Optionally, provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband/or as part of a carrier wave. Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention.

It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Data and/or program code may be accessed and/or shared over a network, for example the Internet. For example, data may be shared and/or accessed using a social network. A processor may include remote processing capabilities for example available over a network (e.g., the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

As used herein the term “about” refers to +10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

As used herein, the terms “multiple” and “multi” are used interchangeably, and mean one or more, e.g., 1, 2, 3, 4, 5, 10, 20, etc.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An electronic money box comprising:
a cash reservoir a cash insertion slot leading from outside reservoir into the cash reservoir;
at least one means of receiving an electronic contribution from a user;
a display, wherein the display is configured for electronic advertising of a plurality of charity campaigns;
a processor configured to configured to control the display; and
a network connection, wherein the electronic money box is connected through the network connection to at least one of: a financial institution, a monetary account of a charity, a monetary account of an individual, additional electric money boxes, and an internet site of the charity campaign.

2. The electronic money box of claim 1, wherein said display is configured to display donor dedication specified by a donor to the money box.

3. The electronic money box of claim 1, wherein said display is configured to display donor dedication specified by a donor to at least one of the plurality of campaigns made without use of the money box.

4. The electronic money box according to claim 1, further comprising at least one of proximity sensor, an optical sensor configured to sense a quantity of cash deposited in the money box.

5. The electronic money box according to claim 1, configured to accept a contribution from a debit card, credit card, or financial mobile application.

6. The electronic money box according to claim 1, wherein the electric money box is connected to another electric money boxes via the network connection.

7. The electronic money box according to claim 1, further comprising a user interface is configured for entry of a dedication.

8. The electronic money box according to claim 7, wherein the user interface includes a mobile application running on an external device owned by the user.

9. The electronic money box according to claim 7, wherein the dedication appears on the display.

10. The electronic money box according to claim 7, wherein the dedication is displayed remotely.

11. A method for use of an electronic money box, the method comprising:
advertising multiple charity campaigns on a display of an electronic money box;
selecting a campaign of a plurality of charity campaigns;
depositing a cash donation into the box to aid particular campaign.

12. The method of claim 11, wherein said selecting is by depositing said cash while said particular campaign appears on said display.

13. The method of claim 11, further comprising recording an amount donated with a user interface.

14. The method according to claim 11, further comprising connecting the electric money box to a user computing device through a wireless connection selected from: a cellular network, satellite network, Wi-Fi, Bluetooth, near field communication system, or any combination thereof.

15. The method according to claim 11, further comprising using the electric money box to make an electronic donation to one of said plurality of campaigns.

16. The method according to claim 11, further comprising entering a dedication along with the donation.

17. The method of claim 16, wherein said entering is via a user interface native to said money box.

18. The method of claim 16, wherein said entering is via a user interface of a device of a donor transmitted to said money box via at least one of a network and a wireless connection.

19. The method according to claim 16, further comprising displaying the dedication on at least one of: the display, displays of linked devices, an internet page, as a notification to a personal computing device, or a combination thereof.

20. The method according to claim 11, further comprising distributing cash donations to the electronic money box in at least one way selected from proportionally according to recorded amounts for cash contributions to each of said plurality of charity campaigns, proportionally to a number of cash contributions to each of said plurality of charity campaigns, according to agreements with plurality of charity campaigns and according to an amount of time each of said plurality of charity campaigns was displayed.
